(19) United States
(12) Patent Application Publication
(10) Pub. No.: US 2019/0019107 A1
(43) Pub. Date: Jan. 17, 2019

(54) METHOD OF MACHINE LEARNING BY REMOTE STORAGE DEVICE AND REMOTE STORAGE DEVICE EMPLOYING METHOD OF MACHINE LEARNING

(71) Applicant: Samsung Electronics Co., Ltd., Suwon-si (KR)

(72) Inventors: Ramdas P. Kachare, Cupertino, CA (US); Sompong Paul Olarig, Pleasanton, CA (US); David Schwaderer, Saratoga, CA (US)

(21) Appl. No.: 15/706,393

(22) Filed: Sep. 15, 2017

Related U.S. Application Data
(60) Provisional application No. 62/531,786, filed on Jul. 12, 2017.

(51) Int. Cl. G06N 99/00; G06F 17/30; G06F 3/06

(52) U.S. Cl. CPC G06N 99/005; G06F 17/30265; G06F 3/0631; H04L 43/106; G06F 17/30569; G06F 3/061; G06F 17/30253

(57) ABSTRACT

A data storage system includes: a host including a processor and a memory; and a remote storage device separate from the host and configured to communicate with the host via an external network. The remote storage device includes: a non-volatile memory device; and a controller configured to control the non-volatile memory device. The controller is configured to create K-metadata objects corresponding to each file stored on the memory device independently of the host, and the K-metadata objects store data describing attributes of the corresponding file stored on the memory device.

### CROSS-REFERENCE TO RELATED APPLICATION

This utility patent application claims priority to and the benefit of U.S. Provisional Patent Application Ser. No. 62/531,786, filed Jul. 12, 2017 and entitled “A METHOD FOR MACHINE LEARNING BY EXAMPLE WITH NVME-OF ETHERNET SSD,” the entire content of which is incorporated herein by reference.

### BACKGROUND

### 1. Field

Aspects of example embodiments of the present invention relate to a method of machine learning by a remote storage device and a remote storage device employing the method of machine learning.

### 2. Related Art

Recently, a demand for high-capacity, high-performance storage devices has increased. For example, file sizes continue to increase as digital content becomes even more complex and an increasing amount of information is being stored due to, for example, the advancement of social networks, health care, and the Internet of Things (IoT). In addition, cloud computing has become more popular, allowing users to remotely store and access large amounts of data, giving users freedom to work on more compact devices while not being constrained by local storage limitations. However, these advancements have placed additional burdens on existing data centers, servers, and data access protocols by increasing the amount of data that is being transferred between the data center and the users. In addition, there is a need to monetize the stored data by extracting actionable information from the stored data.

Recently, machine learning (ML) has been employed to assist with the processing, analysis, and monetization of large data sets to extract useful information from the data sets. Generally, data is inputted from a host and transferred to a remote storage device for longer-term storage. Then, when the stored data is to be processed, analyzed, monetized, etc., it is transferred from the remote storage device back to the host or to another host for the processing, analyzation, etc. The host or hosts will process the stored data in smaller subsets, for example, by using machine learning to extract information about the data and correlate it with other stored data. After it is processed, the stored data is returned to the remote storage device with additional metadata associated with the stored data storing the learned or extracted attributes of the data. This process may be repeated until all the data stored on the remote storage device is processed. However, due to frequent additions and/or modifications to the data, this process may continue substantially indefinitely in the background.

Transferring data between the host and the data center is energy inefficient and ties up a finite amount of bandwidth between the host and the remote storage device. As the transfer of data between the host and the remote storage device continues repeatedly so the host can process the stored data, excessive energy is consumed and other data transfers between the host and the remote storage device or other hosts and the remote storage device may be slowed.

### SUMMARY

The present disclosure is directed toward various embodiments of a method of machine learning by a remote storage device and a remote storage device employing the same.

According to one embodiment of the present invention, a data storage system includes: a host including a processor and a memory; and a remote storage device separate from the host and configured to communicate with the host via an external network. The remote storage device includes: a non-volatile memory device; and a controller configured to control the non-volatile memory device. The controller is configured to create K-metadata objects corresponding to each file stored on the memory device independently of the host, and the K-metadata objects stores data describing attributes of the corresponding file stored on the memory device.

The K-metadata objects may store a time at which the corresponding files were stored on the memory device.

The K-metadata objects may store data describing similar attributes between different ones of the files stored on the memory device.

The K-metadata objects may store a confidence level corresponding to the data describing the similar attributes between different ones of the files stored on the memory device.

The controller may be configured to receive template files, and the template files may include a file and a pre-configured K-metadata object.

The K-metadata objects may not be visible to the host.

The controller may be configured to scan the files stored on the memory device to determine whether or not the files have an attribute.

The external network may include an Ethernet network.

The host and the remote storage device may communicate using a NVMe-oF protocol.

According to another embodiment of the present invention, a method of data storage by a remote storage device is provided. The remote storage device includes a controller and a non-volatile memory device, and the method includes: receiving an input file to the remote storage device from a host over a network connection; storing the input file on the memory device; creating a K-metadata object corresponding to the input file in the memory device, the K-metadata object including data of an attribute of the input file; scanning other stored files on the memory device for attributes; and when one of the stored files is determined to have the attribute of the input file, updating a second K-metadata object corresponding to the one of the stored files to indicate having the attribute.

The updating of the second K-metadata object may further include updating the second K-metadata object to indicate a degree of confidence of the one of the stored files having the attribute.

The method may further include when another one of the stored files is determined to not have the attribute of the input file, updating a third K-metadata object corresponding to the other one of the stored files to indicate not having the attribute.

The updating of the third K-metadata object may further include updating the third K-metadata object to indicate a degree of confidence of the other one of the stored files not having the attribute.

The scanning the other files may occur when the remote storage device is idle.

According to another embodiment of the present invention, a method of machine learning by example by a remote storage device is provided. The remote storage device includes a controller and a non-volatile memory device, and the method includes: receiving a template to the remote storage device, the template including a file and a corresponding attribute to train a machine learning algorithm; scanning other files stored on the memory device to determine whether or not the other files have the attribute of the template; and when one of the stored files is determined to have the attribute of the template, updating a K-metadata object corresponding to the one of the stored files to indicate that the one of the stored files has the attribute.

The controller of the remote storage device may perform the scanning of the other files.

The updating of the K-metadata object may further include updating the K-metadata object to indicate a degree of confidence of the one of the stored files having the attribute.

The method may further include scanning the other files stored on the memory device to determine whether or not the other files do not have the attribute of the template, and when another one of the stored files is determined to not have the attribute of the template, updating a second K-metadata object corresponding to the other one of the stored files to indicate the other one of the stored files does not have the attribute.

The updating of the second K-metadata object may further include updating the second K-metadata object to indicate a degree of confidence of the other one of the stored files not having the attribute.

The controller may include a graphics processing unit (GPU), a central processing unit (CPU), a field-programmable gate array (FPGA), an application-specific integrated circuit (ASIC), or a tensor processing unit (TPU) configured to perform the scanning of the other files stored on the memory device.

This summary is provided to introduce a selection of features and concepts of example embodiments of the present invention that are further described below in the detailed description. This summary is not intended to identify key or essential features of the claimed subject matter nor is it intended to be used in limiting the scope of the claimed subject matter. One or more of the described features according to one or more example embodiments may be combined with one or more other described features according to one or more example embodiments to provide a workable method or device.

### BRIEF DESCRIPTION OF THE DRAWINGS

FIG. 1 illustrates a configuration of a host communicating with a remote storage device;

FIG. 2 illustrates a configuration of a plurality of remote initiators communicating with a remote storage device via a local host;

FIG. 3 is a schematic depiction of raw data and various levels of K-metadata objects stored on the remote storage device; and

FIGS. 4-6 are flowcharts illustrating aspects of a method of machine learning by the remote storage device.

### DETAILED DESCRIPTION

The present disclosure is directed toward various example embodiments of a method of machine learning by a remote storage device and a remote storage device employing the method of machine learning. In one example embodiment, a host and a remote storage device, such as a remote solid-state storage device, communicate with each other via a network. In some embodiments, the host and the remote storage device may communicate over an external network, such as an Ethernet connection using the NVMe-oF protocol with remote Direct Attached Storage (rDAS), but the present invention is not limited thereto. The host may include a processor, such as a central processing unit (CPU) and/or a field-programmable gate array (FPGA), and memory, such as static random-access memory (SRAM) and/or dynamic random-access memory (DRAM), configured to communicate with the processor.

The remote storage device may include a controller and a plurality of memory devices configured to communicate with the controller. The memory devices may be or may include solid-state storage devices, such as solid-state drives (SSDs) or Ethernet-attached solid-state devices (eSSDs), to store data; however, the present invention is not limited thereto. In some embodiments, the remote storage device may be a solid-state storage devices including the controller and a plurality of flash memory chips in the solid-state storage device. In other embodiments, the memory devices may be or may include hard disk drives (HDDs) and tape drives, as well as future storage devices based on emerging solid-state technologies, such as 3D-Xpoint or phase-change memory. The remote storage device is configured to analyze the stored data by using machine learning algorithms. The controller of the remote storage device may run the machine learning algorithms on the memory devices, or each of the memory devices may run the machine learning algorithms internally. By conducting the machine learning (e.g., by running the machine learning algorithms) at the remote storage device, the stored data does not need to be repeatedly transferred from the remote storage device to the host and back for processing, thereby reducing energy use and freeing up bandwidth for requested data transfers between the host(s) and the remote storage device.

Hereinafter, example embodiments of the present invention will be described, in more detail, with reference to the accompanying drawings. The present invention, however, may be embodied in various different forms and should not be construed as being limited to only the embodiments illustrated herein. Rather, these embodiments are provided as examples so that this disclosure will be thorough and complete and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element is referred to as being “connected to” or “coupled to” another element, it can be directly connected to or coupled to the other element, or one or more intervening elements may be present. In addition, it will also be understood that when an element is referred to as being “between” two elements, it can be the only element between the two elements, or one or more intervening elements may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components but do not preclude the presence or addition of one or more other features, integers, steps, operations, elements, components, and/or groups thereof. That is, the processes, methods, and algorithms described herein are not limited to the operations indicated and may include additional operations or may omit some operations, and the order of the operations may vary according to some embodiments. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “example” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The processor, storage controller, memory devices, central processing unit (CPU), graphics processing unit (GPU), field-programmable gate array (FPGA), and/or any other relevant devices or components according to embodiments of the present invention described herein may be implemented utilizing any suitable hardware (e.g., an application-specific integrated circuit), firmware, software, and/or a suitable combination of software, firmware, and hardware. For example, the various components of the processor, storage controller, memory devices, CPU, GPU, and/or the FPGA may be formed on one integrated circuit (IC) chip or on separate IC chips. Further, the various components of the processor, storage controller, memory devices, CPU, GPU, and/or the FPGA may be implemented on a flexible printed circuit film, a tape carrier package (TCP), a printed circuit board (PCB), or formed on the same substrate as the processor, storage controller, memory devices, CPU, GPU, and/or the FPGA. Further, the described actions may be processes or threads, running on one or more processors, in one or more computing devices, executing computer program instructions and interacting with other system components to perform the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present invention.

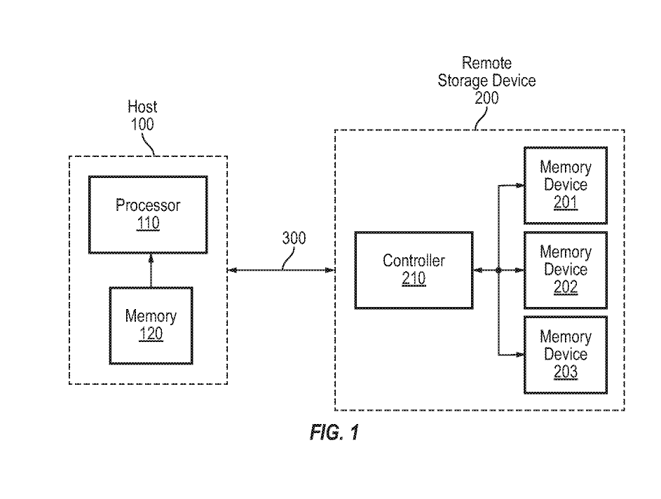

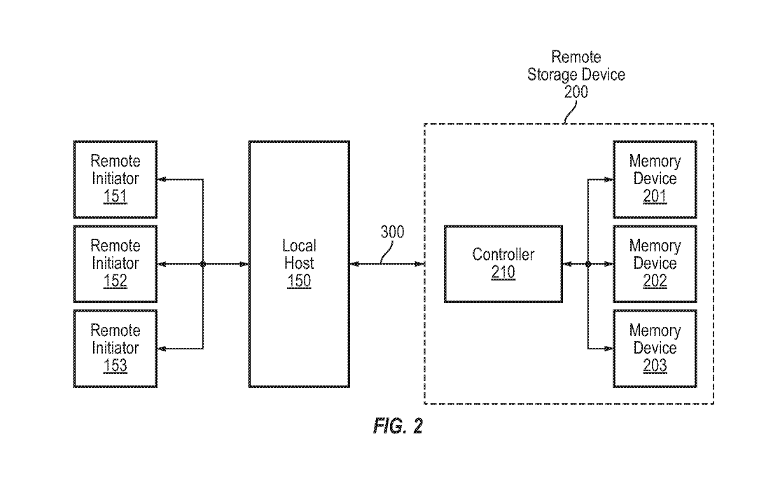

FIG. 1 illustrates a configuration of a host communicating with a remote storage device over an interface using a protocol, and FIG. 2 illustrates a configuration of a plurality of remote initiators communicating with a remote storage device via a local host over an interface using a protocol. Here, the interface may be the Internet and/or an Ethernet interface, and the protocol may be the Non-Volatile Memory Express (NVMe) over Fabrics (NVMe-oF) protocol. However, the present invention is not limited to the above-described interfaces or protocol.

In FIG. 1, the host 100 may include a processor 110, such as a central processing unit (CPU), a field-programmable gate array (FPGA), an application-specific integrated circuit (ASIC), a graphics processing unit (GPU), and/or a tensor processing unit (TPU) coupled to memory 120, such as a static random-access memory (SRAM) or dynamic random-access memory (DRAM). The processor 110 may be any well-known processor configured to execute instructions and to communicate with other components and devices in a computer system. The remote storage device 200 may include a controller 210 and a plurality of memory devices 201-203. For example, each of the plurality of memory devices 201-203 may be a solid-state drives (SSD), such as an Ethernet-attached solid-state drive (eSSD) or the like; however, the present invention is not limited thereto. In other embodiments, the remote storage device 200 may be a single SSD including the controller 210 and a plurality of memory devices 201-203 being a plurality of flash memory chips. The controller 210 may be configured to control (e.g., to update) the memory devices 201-203 (e.g., to handle writes, rewrites, and erases to the memory devices 201-203). The host 100 communicates with the remote storage device 200 via an interface 300. The interface 300 may be an Ethernet interface communicating over a local network (e.g., a local area network or LAN) and/or a wide area network, such as the Internet, and the host 100 and the remote storage device 200 may communicate with each other by using the NVMe-oF protocol. As used herein, the term “remote” indicates that the storage device (i.e., the remote storage device) is external to the host.

In FIG. 2, a plurality of remote initiators 151-153 communicate with the remote storage device 200 via a local host 150 and the interface 300. The local host 150 may include a switch or router that allows the remote initiators 151-153 to communicate with the remote storage device 200 over, for example, a wide or local area network. The remote initiators 151-153 may communication with the local host 150 over a network.

Referring to FIG. 1, the host 100 and the remote storage device 200 may communicate with each other by using the NVMe-oF protocol via a LAN or the Internet, as described above. Similarly, referring to FIG. 2, the local host 150 and the remote storage device 200 may communication with each other by using the NVMe-oF protocol via a LAN or the Internet.

In use, data (e.g., files, objects, key/value pairs, etc.) may be input into the host 100 or one of the remote initiators 151-153 (see, e.g., FIG. 2) and may be transferred to the remote storage device 200 via the interface 300. As one example, a user may upload an image or an audio track to the host 100 or one of the remote initiators 151-153 and then save the image or audio track to the remote storage device 200 (e.g., to one or more of the memory devices 201-203 of the remote storage device 200) via the interface 300.

While the data stored on the remote storage device 200, such as the image or the audio track, may be identified by the controller 210 for later retrieval when desired by a user or host, the remote storage device 200 generally does not have any knowledge or understanding of the content of the stored data. Generally, the remote storage device 200 stores the data and waits for a user or host to request the stored data, at which time it retrieves the stored data and transmits it to the host 100.

As discussed above, there is value in understanding the content of the stored data. Because the remote storage device 200 stores data for one or more hosts 100 or a plurality of remote initiators 151-153, it has access to a relatively large amount of data. In existing systems, in order for the stored data to be processed, analyzed, etc. to understand various characteristics and/or attributes about the stored data, it had to be transferred back to the host or one of the remote initiators 151-153 for processing, requiring network resources to transmit the data and processing resources on the host or remote initiator to process the data.

According to an embodiment of the present invention, the remote storage device 200 performs a machine learning process or method to make inferences about the stored data, such as to make inferences about characteristics and/or attributes of the stored data. By performing the machine learning process at the remote storage device 200, the stored data does not need to be transmitted back to the host 100 or one of the remote initiators 151-153, thereby reducing or eliminating the need for network resources to conduct the machine learning. Also, the stored data is processed or analyzed by using a processor, such as a CPU, GPU (graphics processing unit), or FPGA, in the controller 210 and/or in each of the memory devices 201-203, thereby reducing a burden on the host or the remote initiators 151-153. For example, when each of the memory devices 201-203 includes a processor, such as a CPU, GPU, or FPGA, the machine learning process may be conducted on each of the memory devices 201-203. In other embodiments, the machine learning process may be performed by the controller 210, which may include a processor, and which is external to memory devices 201-203 and also remote to the host 100 or the remote initiators 151-153. For example, the controller 210 may be housed in the same chassis as the memory devices 201-203 and may control the memory devices 201-203. For convenience of explanation, the remote storage device 200 will be referred to as performing the machine learning process or method, and this is intended to encompass embodiments in which the memory devices 201-203 perform the machine learning, embodiments in which the controller 210 performs the machine learning, and embodiments in which the both controller 210 and the memory devices 201-203 jointly or separately perform the machine learning.

In some embodiments, the machine learning process or method includes extracting and/or inferring various attributes and/or characteristics of the stored data and storing the attributes and/or characteristics as so-called knowledge metadata (“K-metadata”) in K-metadata objects. In some embodiments, the K-metadata objects are files stored in the remote storage device 200 separate from the stored data and include the pre-assigned attributes and/or characteristics of the stored data provided to the remote storage device 200 and/or the determined and/or inferred attributes and/or characteristics of the stored data that result from the machine learning, to be further described below. However, the present invention is not limited thereto, and in other embodiments, the K-metadata objects may be a part of the stored data, such as when stored data is of a type that allows for internal storage of metadata, such as a key value store. That is, the K-metadata objects are not limited to being either external to corresponding data (e.g., a separate file) or internal to corresponding data (e.g., as a key value) but may vary depending based on the file type of the data, for example. The host 100 or the remote initiators 151-153 may not have access to or even knowledge of the K-metadata objects on the remote storage device 200.

The machine learning performed by the remote storage device 200 may be assisted (or trained) by providing examples or templates to the remote storage device 200, may be unassisted by identifying and grouping attributes and/or characteristics of the stored data, or may be a combination of both assisted and unassisted machine learning.

The unassisted machine learning may include storing attributes and/or characteristics about stored data's content (e.g., the actual image data of a picture file) and/or the store data's metadata. For example, such metadata may include the time (e.g., date and time) at which a file is stored in the remote storage device 200, and this information may be stored in a corresponding K-metadata object. Such attributes and/or characteristics can be recognized by the remote storage device 200 without the assistance of a template. Other such attributes and/or characteristics of stored data may include, but are not limited to, sequence number, file type, file size, and time of last change or modification. When data is stored on the remote storage device 200, a K-metadata object may be created corresponding to each file in the stored data, and the K-metadata object may be populated with these attributes and/or characteristics of the corresponding stored file.

The assisted machine learning (e.g., training of the machine learning algorithm) may include providing templates or examples to the remote storage device 200. For example, the template may be data having known or pre-identified (or pre-assigned) attributes and/or characteristics, and the data may be stored in the remote storage device 200 along with the known or pre-identified attributes. In some embodiments, the template may include data (e.g., one or more files) along with a corresponding pre-generated K-metadata object that is stored on the remote storage device 200. In other embodiments, the template may include data along with certain pre-identified attributes stored in metadata associated with the file, such as a hidden part of a key, that the remote storage device 200 interprets as referring to an attribute of the file. In other embodiments, the template information may be input to the remote storage device 200 as a separate file including batch association information corresponding a plurality of previously or soon-to-be input files with a certain attribute. In other embodiments, the template may be a particular write command used when a file is input to the remote storage device 200 indicating the corresponding input file has a certain attribute. However, the present invention is not limited to these examples.

When the remote storage device 200 receives the template, the remote storage device 200 scans the other stored data for data having attributes and/or characteristics similar to or the same as the known attributes and/or characteristics of the template. The remote storage device 200 may then update existing K-metadata objects corresponding to the scanned files based on the results of the scan or may create new K-metadata objects and populate them based on the results of the scan. For example, when the stored data has or substantially has the pre-determined attribute and/or characteristic of the template, the corresponding K-metadata object may be updated or created and populated with information pertaining to that attribute and/or characteristic.

As one specific example useful to illustrate aspects of embodiments of the present invention, when two images, a first image of a dog and a second image of a cat, are input into the host 100 or one of the remote initiators 151-153 and then stored on the remote storage device 200, the remote storage device 200 creates two K-metadata objects, one each corresponding to the two images. At this point, the remote storage device 200 is unaware that the images are of dogs and cats, so that information is not yet in the associated k-metadata objects. Alternatively or additionally, both the first and second K-metadata objects may be created based on metadata of the respective first and second images, such as the time of writing and a sequence number, for example. That is, the K-metadata objects may be created and then populated with certain attributes and/or characteristics of the corresponding files.

Then, a user may input a template to the remote storage device 200 from the host 100, one of the remote initiators 151-153, or by some other method, such as a USB connection to the remote storage device 200. In one example, the template may include one or more images of a dog and a corresponding K-metadata object indicating that the corresponding images have the attribute of being a dog. Based on this provided template, the machine learning algorithm run by the remote storage device 200 may be trained to recognize images of dogs. The remote storage device 200 may then scan all stored data for other files, such as image files, to determine whether or not they have similar attributes and/or characteristics as the template image. When the remote storage device 200 scans the image of a dog mentioned above, it may determine that this image has similar features as the template image(s) and may then update the corresponding K-metadata object related to the test image to indicate the attribute of being an image of a dog. When the remote storage device 200 scans the image of a cat mentioned above, it may determine that this image does not have similar features as the template image(s). In this case, the remote storage device 200 may not update the K-metadata object corresponding to the second image or may update the K-metadata object corresponding to the second image to indicate that it is not an image of a dog.

In some embodiments, the remote storage device 200 may not only update the K-metadata objects to indicate the presence and/or absence of certain attributes and/or characteristics in a certain file but may also update the K-metadata objects to indicate a degree of confidence that the scanned filed has a certain attribute and/or characteristic. For example, returning to the above example, when the remote storage device 200 scans the first image of a dog in response to the template being inputted into the remote storage device 200, the K-metadata object corresponding to the first image may be further updated to indicate a degree of confidence that the first image has or does not have the attribute and/or characteristic of the template image. For example, the remote storage device 200 may update the K-metadata object corresponding to the first image with a confidence level, such as high or low confidence, referring to the degree of confidence that the first image is of a dog, similar to the template image. When the remote storage device 200 scans the second image of a cat in response to the template being inputted into the remote storage device 200, the K-metadata object corresponding to the second image may be further updated to indicate a degree of confidence. For example, the remote storage device 200 may update the K-metadata object corresponding to the second image to indicate a high degree of confidence that the second image is not of a dog and/or a low degree of confidence that the second image is of a dog.

If a user then searches the remote storage device 200 for an image of a dog, the remote storage device 200 may prioritize retrieval and transmission of the first image based on the corresponding K-metadata object indicating that it is an image of a dog and may deprioritize retrieval and transmission of the second image based on the corresponding K-metadata object indicating that it is not an image of a dog. When many images are stored on the remote storage device, the remote storage device 200 may prioritize retrieval and transmission of images having corresponding K-metadata objects indicating that they are images of a dog with highest priority going to images with the highest degree of confidence that the image is of a dog. As such, the first results provided to a user are most likely to be images of a dog while later results are less likely to be images of a dog.

The process of scanning the stored data (e.g., the machine learning process) may be performed in the background on the remote storage device 200. For example, the scanning process may be performed when there are no pending read/write commands on the remote storage device 200 or when there are fewer than a certain number of pending read/write commands so as to not interrupt or not substantially interrupt users' access to the remote storage device 200. In addition, because the scanning the stored data occurs on the remote storage device 200, bandwidth between the host 100 or the remote initiators 151-153 and the remote storage device 200 is not occupied during the scanning process, reducing energy consumption and preventing system slowdowns by reducing network congestion.

In addition, the scanning may be performed within the memory devices 201-203, for example, on a controller in each of the memory devices 201-203, by the controller 210 of the remote storage device 200, or some combination thereof. In some embodiments, an additional FPGA, CPU, and/or GPU may be provided in the remote storage device 200 to increase the scanning speed and reduce the time required to scan the files on the remote storage device 200.

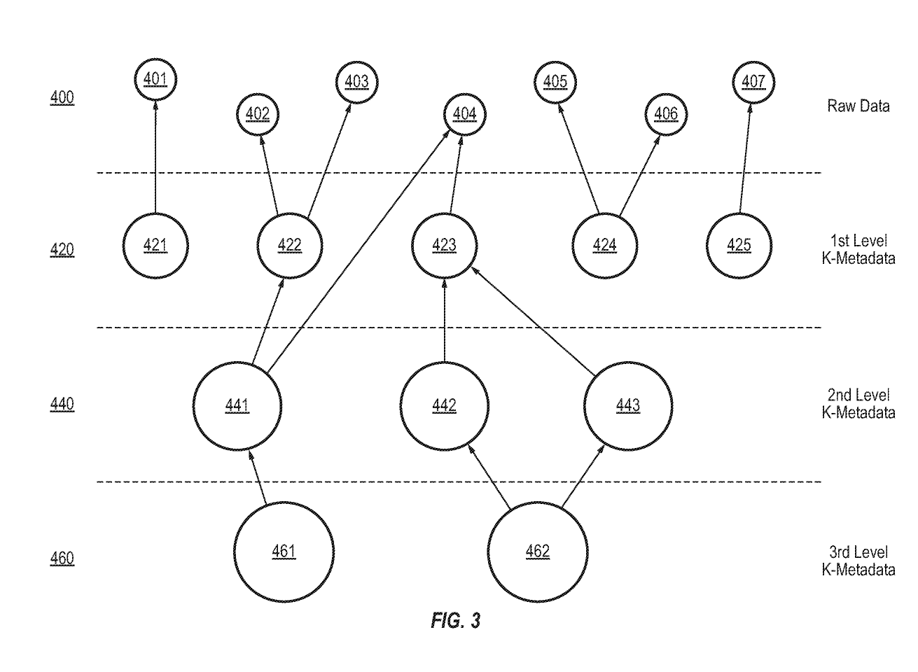

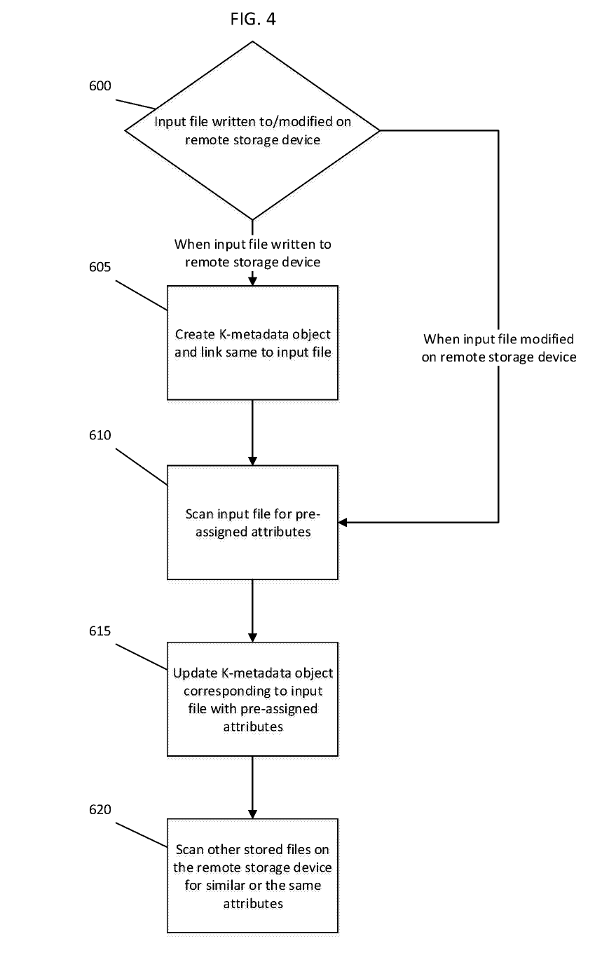

FIG. 3 is a schematic depiction of raw data and various levels of K-metadata objects stored on the remote storage device. As can be seen in FIG. 3, the K-metadata objects may be stored in (e.g., organized into) different levels 420, 440, 460. For example, in FIG. 4, the stored data is schematically illustrated as being at level 400 and including stored files 401-407.

A first level 420 of K-metadata objects 421-425 may represent a most basic level of K-metadata objects. The first-level K-metadata objects 421-425 may be the K-metadata objects created when new files are stored on the remote storage device 200 and may include the time of storage, time of last modification, sequence number, and/or pre-defined attributes. Further, the first-level K-metadata objects 421-425 may store attributes and/or characteristics of one or only a few of the files 401-407. That is, each of the first-level K-metadata objects 421-425 may correspond to one or only a few of the files 401-407. In FIG. 3, the K-metadata objects 421, 423, and 425 are illustrated as having one-to-one correspondence with the files 401, 404, and 407, respectively and the K-metadata objects 422 and 424 are illustrated as having one-to-two correspondence with the files 402/403 and 405/406, respectively, although this need not be the case in any particular instance. The K-metadata objects 422 and 424 having the one-to-two correspondence may be created when the corresponding files 402/403 and 405/406 are written to the remote storage device 200 at substantially the same time, have the same file type, same file size, etc., but the present invention is not limited thereto. In some embodiments, a single K-metadata object may be created that corresponds to two or more files when the files have the same or substantially similar attribute and/or characteristic.

A second level 440 of K-metadata objects 441-443 may represent a middle-level of the K-metadata objects. The second-level K-metadata objects 441-443 may be linked to (e.g., may refer to) ones of the first-level K-metadata objects 421-425 and/or the files 401-407 (e.g., may be linked directly to the files 401-407). In FIG. 3, the second-level K-metadata object 441 is shown as being linked to both the first-level K-metadata object 422 and the file 404 (and also linked to a third-level K-metadata object 461, to be discussed in more detail below), the second-level K-metadata object 442 is shown as being linked to the first-level K-metadata object 423 (and to a third-level K-metadata object 462, to be discussed in more detail below), and the second-level K-metadata object 443 is shown as being linked to the first-level K-metadata object 423 (and to the third-level K-metadata object 462, to be discussed in more detail below), although various suitable arrangements of links are possible and are contemplated.

The second-level K-metadata objects 441-443 may be created after the files 401-407 are written to the remote storage device 200 and may be written after the first-level K-metadata objects 421-425 corresponding to the files 401-407 are created. For example, the second-level K-metadata objects 441-443 may be created in response to a template being uploaded to the remote storage device 200 that triggers a scan of the files 401-407. However, the present invention is not limited thereto, and the second-level K-metadata objects 441-443 may be created at any time the remote storage device 200 determines such a K-metadata object would be useful or desired. For example, during background scanning, the remote storage device 200 may determine the same or substantially similar attribute and/or characteristic between two or more of the first-level K-metadata objects 421-425 and/or two of more of the files 401-407 and may create a new second-level K-metadata object corresponding to that attribute and/or characteristic, may update an existing second-level K-metadata object to include that attribute and/or characteristics, and/or may create a new link between an existing second-level K-metadata object and one of the first-level K-metadata objects and/or the corresponding file(s). Returning to example of a first image of a dog and a second image of a cat above, the second-level K-metadata objects 441-443 may be created when the remote storage device 200 determines that, for example, images of a cat often include a mouse with the cat while images of a dog do not also include a mouse. Thus, some of the second-level K-metadata object 441-443 may be linked to the first-level K-metadata objects 401-407 that indicate the corresponding image is of a cat and to the first-level K-metadata objects 401-407 that the image is of a mouse, thus resulting in second-level K-metadata objects 441-443 that correspond to images of both a cat and a mouse. That is, the second-level K-metadata objects 441-443 may be created in response to statistical analysis of the first-level K-metadata objects 401-407

A third level 460 of K-metadata objects 461 and 462 may represent an upper-most level of the K-metadata objects, but the present invention is not limited thereto. For example, the number of levels of the K-metadata objects may not be limited to any particular number. The third-level K-metadata objects 461 and 462 may be linked to any of the second-level K-metadata objects 441-443, the first-level K-metadata objects 421-425, and/or the files 401-407. Similar to the second-level K-metadata objects 441-443, the third-level K-metadata objects 461 and 462 may be created at any time the remote storage device 200 determines such a K-metadata object would be useful based on, for example, statistical analysis of the second-level K-metadata objects 441-443. For example, during background scanning, the remote storage device 200 may determine the same or substantially similar attribute and/or characteristic between two or more of the second-level K-metadata objects 441-443, two or more of the first-level K-metadata objects 421-425, and/or two of more of the files 401-407 and may create a new third-level K-metadata object corresponding to that attribute and/or characteristic, may update an existing third-level K-metadata object to include that attribute and/or characteristics, and/or may create a new link between an existing third-level K-metadata object and the an existing second-level K-metadata object(s), an existing first-level K-metadata object(s), and/or the corresponding file(s).

FIG. 4 is a flowchart illustrating an embodiment of a method of machine learning by the remote storage device 200. First, an input file is written to, or a previously-stored file (referred to as the input file throughout the description for convenience of explanation) is modified in, the remote storage device 200 (600). When the input file is a new file, the remote storage device 200 creates a new K-metadata object and links the new K-metadata object to the input file (605). When the input file is an existing file on the remote storage device 200 (e.g., when the previously-stored file is modified in step 600), a new K-metadata object may not be created.

The input file is scanned for pre-assigned attributes, as discussed above (610). For example, the pre-assigned attributes may refer to or may be stored in pre-existing metadata corresponding to the input file, such as the time of writing or updating, etc. or may refer to metadata associated with the file, etc. as described above. In some embodiments, the input file may be a plurality of files each having a similar per-assigned attribute on which the learning algorithm may train. When the input file is the new file, the new K-metadata object corresponding to the input file is updated to include the pre-assigned attributes (e.g., to refer to the pre-assigned attributes) of the input file (615). When the input file is the modified existing file, the input file is scanned for modification to its pre-assigned attributes (610), such as identification that the input file has some attribute, and then, the existing K-metadata object corresponding to the input file is updated corresponding to any change in the pre-assigned attributes of the input file (610). However, the present invention is not limited to any particular order of steps. For example, the input file may be scanned for pre-assigned attributes before the new K-metadata object corresponding to the input file is created.

Next, the remote storage device 200 scans other stored files and/or other K-metadata objects for similar or the same attributes as those in the K-metadata object corresponding to the input file (620).

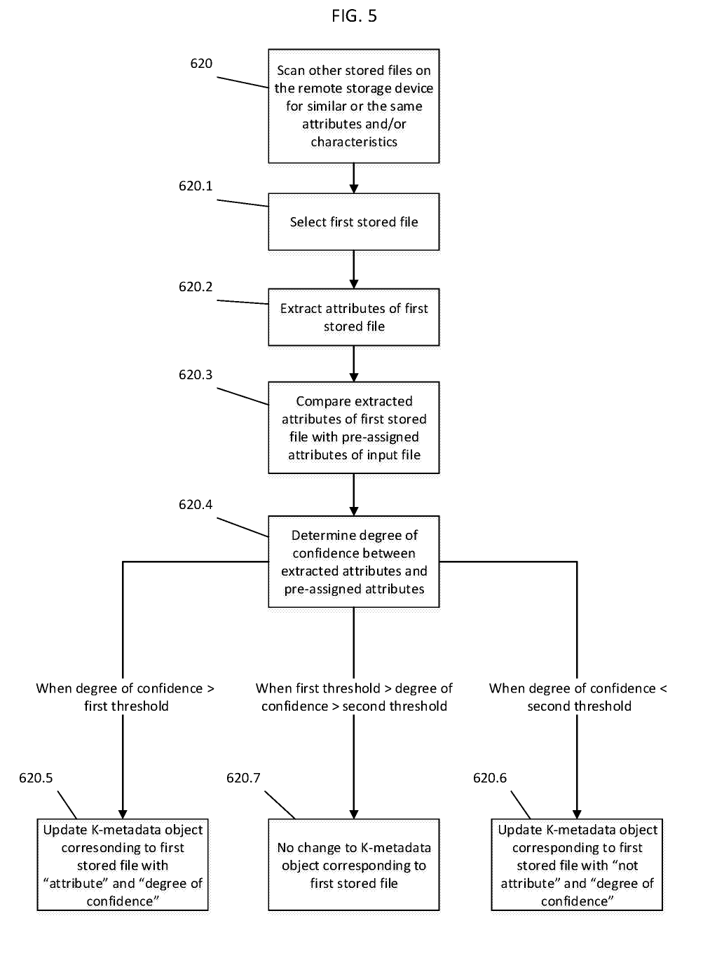

FIG. 5 is a flowchart illustrating an embodiment of sub-steps of the step 620 shown in FIG. 4. In one embodiment, the scanning of the other stored files (620) includes selecting a first stored file on the remote storage device 200 (620.1). Next, attributes of the first stored file are extracted (620.2). The extraction of the attributes of the first stored file may include scanning the first stored file directly and/or scanning the K-metadata object(s) corresponding to the first stored file.

Next, the remote storage device 200 (e.g., the controller 210 or a controller in various ones of the memory devices 201-203) compares the extracted attributes of the first stored file with the pre-assigned attributes of the input file (620.3). The remote storage device 200 then determines a degree of confidence between the extracted attributes of the first stored file and the pre-assigned attributes of the input file (620.4). When the degree of confidence is greater than a first threshold (e.g., an upper threshold), indicating that the remote storage device 200 understands (or has determined) the extracted attribute of the first stored file and the pre-assigned attribute of the input file to be similar or the same, the remote storage device 200 updates the K-metadata object corresponding to the first stored file with the attribute and the degree of confidence (620.5). When the degree of confidence is lower than a second threshold (e.g., a lower threshold), the remote storage device 200 may update the K-metadata object corresponding to the first stored file indicating it does not have the pre-assigned attribute and the degree of confidence (620.6). When the degree of confidence is between the first and second thresholds, the remote storage device 200 does not update the K-metadata object corresponding to the first stored file (620.7). The remote storage device 200 may repeat the step 620 for every stored file on the remote storage device 200 or may only repeat the step 620 for stored files having the same type as the input file (e.g., video files, audio files, etc.).

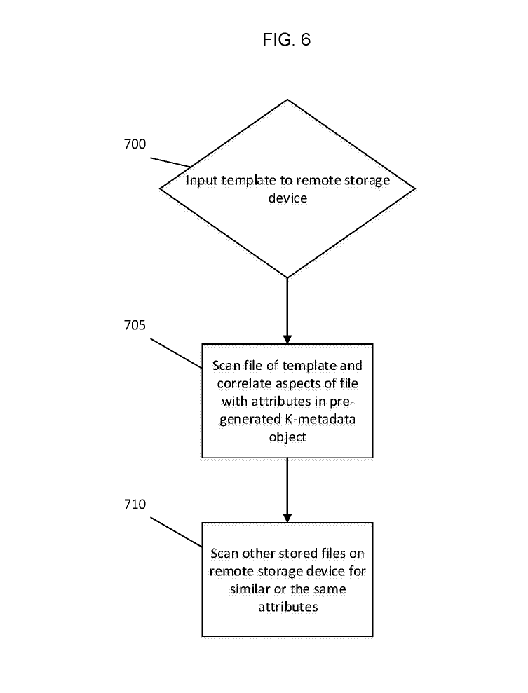

FIG. 6 is a flowchart illustrating an embodiment of a method of machine learning by the remote storage device 200 when a template is input to the remote storage device 200. First, a template is inputted to the remote storage device 200 (700). The template includes a file along with a corresponding pre-generated K-metadata object, as discussed above. However, in other embodiments, the template may include a file along with an attribute. In this case, the remote storage device 200 may create a K-metadata object and populate the K-metadata object with the attribute and the corresponding degree of confidence being high or maximum.

Next, the remote storage device 200 may scan the file of the template and correlate aspects of the file with the attribute in the corresponding pre-generated K-metadata object (705).

Then, the remote storage device 200 scans the other stored files on the remote storage device 200 for similar or the same attributes as those of the template (710). The scanning the other stored files on the remote storage device 200 (710) may be conducted in the same or in a substantially similar manner as the scanning the other stored files (620) as described above with respect to FIG. 5 and will not be repeated herein. For example, rather than comparing the extracted attributes of the first stored file with the pre-assigned attributes of the input file (620.3), in the method illustrated in FIG. 6 the remote storage device 200 compares the extracted attributes of a stored file with the attributes of the file as according to the pre-generated K-metadata objection as determined by the remote storage device 200 at step 705.

Although the present invention has been described with reference to the example embodiments, those skilled in the art will recognize that various changes and modifications to the described embodiments may be performed, all without departing from the spirit and scope of the present invention. Furthermore, those skilled in the various arts will recognize that the present invention described herein will suggest solutions to other tasks and adaptations for other applications. It is the applicant's intention to cover by the claims herein, all such uses of the present invention, and those changes and modifications which could be made to the example embodiments of the present invention herein chosen for the purpose of disclosure, all without departing from the spirit and scope of the present invention. Thus, the example embodiments of the present invention should be considered in all respects as illustrative and not restrictive, with the spirit and scope of the present invention being indicated by the appended claims and their equivalents.

What is claimed is:

1. A data storage system comprising:
a host comprising a processor and a memory; and
a remote storage device separate from the host and configured to communicate with the host via an external network, the remote storage device comprising:
a non-volatile memory device; and
a controller configured to control the non-volatile memory device,
wherein the controller is configured to create K-metadata objects corresponding to each file stored on the memory device independently of the host, the K-metadata objects storing data describing attributes of the corresponding file stored on the memory device.

2. The data storage system of claim 1, wherein the K-metadata objects store a time at which the corresponding files were stored on the memory device.

3. The data storage system of claim 2, wherein the K-metadata objects store data correlating different ones of the files stored on the memory device based on similar attributes therebetween.

4. The data storage system of claim 3, wherein the K-metadata objects store a confidence level corresponding to the similarity of the attributes between the different ones of the files stored on the memory device.

5. The data storage system of claim 1, wherein the controller is configured to receive template files, the template files comprising a file and a pre-configured K-metadata object.

6. The data storage system of claim 1, wherein the K-metadata objects are not visible to the host.

7. The data storage system of claim 1, wherein the controller is configured to scan the files stored on the memory device to determine whether or not the files have an attribute.

8. The data storage system of claim 1, wherein the external network comprises an Ethernet network.

9. The data storage system of claim 8, wherein the host and the remote storage device communicate using a NVMe-oF protocol.

10. A method of data storage by a remote storage device, the remote storage device comprising a controller and a non-volatile memory device, the method comprising:
receiving an input file to the remote storage device from a host over a network connection;
storing the input file on the memory device;
creating a K-metadata object corresponding to the input file in the memory device, the K-metadata object comprising data of an attribute of the input file;
scanning other stored files on the memory device for one or more of the attributes; and
when one of the stored files is determined to have the attribute of the input file, updating a second K-metadata object corresponding to the one of the stored files to indicate having the attribute.

11. The method of claim 10, wherein the updating of the second K-metadata object further comprises updating the second K-metadata object to indicate a degree of confidence of the one of the stored files having the attribute.

12. The method of claim 10, further comprising when another one of the stored files is determined to not have the attribute of the input file, updating a third K-metadata object corresponding to the other one of the stored files to indicate not having the attribute.

13. The method of claim 12, wherein the updating of the third K-metadata object further comprises updating the third K-metadata object to indicate a degree of confidence of the other one of the stored files not having the attribute.

14. The method of claim 10, wherein the scanning the other files occurs when the remote storage device is idle.

15. A method of machine learning by example by a remote storage device, the remote storage device comprising a controller and a non-volatile memory device, the method comprising:
receiving a template to the remote storage device, the template comprising a file and a corresponding attribute to train a machine learning algorithm;
scanning other files stored on the memory device to determine whether or not the other files have the attribute of the template; and
when one of the stored files is determined to have the attribute of the template, updating a K-metadata object corresponding to the one of the stored files to indicate that the one of the stored files has the attribute.

16. The method of claim 15, wherein the controller of the remote storage device performs the scanning of the other files.

17. The method of claim 16, wherein the updating of the K-metadata object further comprises updating the K-metadata object to indicate a degree of confidence of the one of the stored files having the attribute.

18. The method of claim 15, further comprising scanning the other files stored on the memory device to determine whether or not the other files do not have the attribute of the template; and
when another one of the stored files is determined to not have the attribute of the template, updating a second K-metadata object corresponding to the other one of the stored files to indicate the other one of the stored files does not have the attribute.

19. The method of claim 18, wherein the updating of the second K-metadata object further comprises updating the second K-metadata object to indicate a degree of confidence of the other one of the stored files not having the attribute.

20. The method of claim 15, wherein the controller comprises a graphics processing unit (GPU), a central processing unit (CPU), a field-programmable gate array (FPGA), an application-specific integrated circuit (ASIC), or a tensor processing unit (TPU) configured to perform the scanning of the other files stored on the memory device.
